(19) United States
(12) Patent Application Publication
(10) Pub. No.: US 2005/0270460 A1
(43) Pub. Date: Dec. 8, 2005

(54) Electromechanical active matrix display employing an array of lenses and occultating disks

(76) Inventor: Nicholas F. Pasch, Pacifica, CA (US)

Correspondence Address: CARPENTER & KULAS, LLP, 1900 EMBARCADERO ROAD, SUITE 109, PALO ALTO, CA, 94303, US

(21) Appl. No.: 11/142,926

(22) Filed: Jun. 1, 2005

Related U.S. Application Data
(60) Provisional application No. 60/576,384, filed on Jun. 2, 2004.
(60) Provisional application No. 60/656,855, filed on Feb. 25, 2005.

(51) Int. Cl. G02F 1/1335

(52) U.S. Cl. 349/120

(57) ABSTRACT

Display technology incorporating a mirror surfaces or combinations of lenses and mirror surfaces to create displays of improved qualities is disclosed.

### CROSS-REFERENCES TO RELATED APPLICATIONS

This application is related to commonly assigned provisional patent applications entitled “ON THE USE OF LENSES WITH OCCULTATING DISKS FOR PRESENTATION OF GRAPHICAL DATA” by Nicholas F. Pasch, application No. 60/576,384, filed on Jun. 2, 2004 and “MICRO-ELECTROMECHANICAL SWITCH” by Nicholas F. Pasch, et al., application No. 60/656,855, filed on Feb. 25, 2005 the entire disclosures of which are herein incorporated by reference.

### BACKGROUND OF THE INVENTION

1. Field of the Invention

Embodiments of the present invention relate to optical display devices. More particularly, embodiments of the present invention relate to a low cost electromechanical active matrix display.

2. Description of the Background Art

[03] Optical displays such as liquid crystal displays (“LCDs”), plasma displays and organic light emitting displays (OLEDs), electro-luminescent displays, electronic ink paper displays and other pixel-based displays are used in many products such as computer displays, cellular telephones, flat screen televisions, watches, entertainment devices, microwave ovens and many other electronic devices. Today's optical displays rely on a matrix of thin film transistors and (often) corresponding capacitors, deposited on a glass membrane, to control individual pixels. This transistor and capacitor matrix is often referred to as an “active matrix display backplane” or backplane for short. By applying a voltage to a row electrode and a column electrode, the transistor at the intersection of the row and column controls the pixel while the capacitor holds the charge until the next refresh cycle.

Currently optical display technologies have limited fields of view, with degradations of contrast and brightness as an observer exceeds these limits. The phenomenon can be so severe that the display is not visible at all at significant angles. There are times when an off-axis viewing angle is unavoidable, and currently there are no mechanisms to correct the problems so created.

What is also undesirable is a loss of contrast as the display is viewed off axis. Because of the optical layout of the original display, this effect exasperates the normal contrast loss associated with a lens system. What is also needed is a display with improvement in the off axis contrast and the on axis contrast as well.

It may be equally undesirable for a display to have a wide field of view, (e.g., when one does not want an adjacent passenger on an airplane to view a personal laptop computer) and again there is no effective mechanism to create such a display.

Accordingly, there is a need for a display system and methods that enable one or more of the above and/or other problems of existing display technology to be avoided.

### BRIEF DESCRIPTION OF THE DRAWINGS

FIG. 1 is a sectional side view of an exemplary cell in accordance with an embodiment of the present invention.

FIG. 2 is another sectional side view of an exemplary cell in accordance with an embodiment of the present invention.

FIG. 3 is a sectional side view of another exemplary cell in accordance with an embodiment of the present invention.

FIG. 4 is a sectional side view of another exemplary cell in accordance with an embodiment of the present invention.

FIG. 5 is a sectional side view of another exemplary cell in accordance with an embodiment of the present invention.

FIG. 6 is a sectional side view of another exemplary cell in accordance with an embodiment of the present invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. However, embodiments of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A preferred embodiment of uses an array of mechanical switches controlled by row/column electrodes that are accessible by drivers similar in operation to ones currently used in prior art optical displays. The array is used to create nonlinear voltage or current switching responses that are applied or impressed on the optical cells of the display to generate an image. Note that other types of display technologies or electrical design or fabrication techniques can be used in conjunction with those specific technologies, designs or techniques described herein. For example, features of the MEM switching approach can be used with any type of actuator, switch, chemical or physical device or property, etc., to cause an effect suitable for imaging in an optical display. In general, any type of suitable driver or drive signal can be used.

An example of a cell comprising a pixel has been previously disclosed in a utility patent application entitled “MICRO-ELECTROMECHANICAL SWITCHING BACKPLANE” by Michael D. Sauvante, et al., application Ser. No. 10/959,604, filed on Oct. 5, 2004, the disclosure of which is incorporated herein for all purposes. It is preferred that each pixel in a display comprise at least one of such cells except each cell is further adapted as described below in accordance with the present invention.

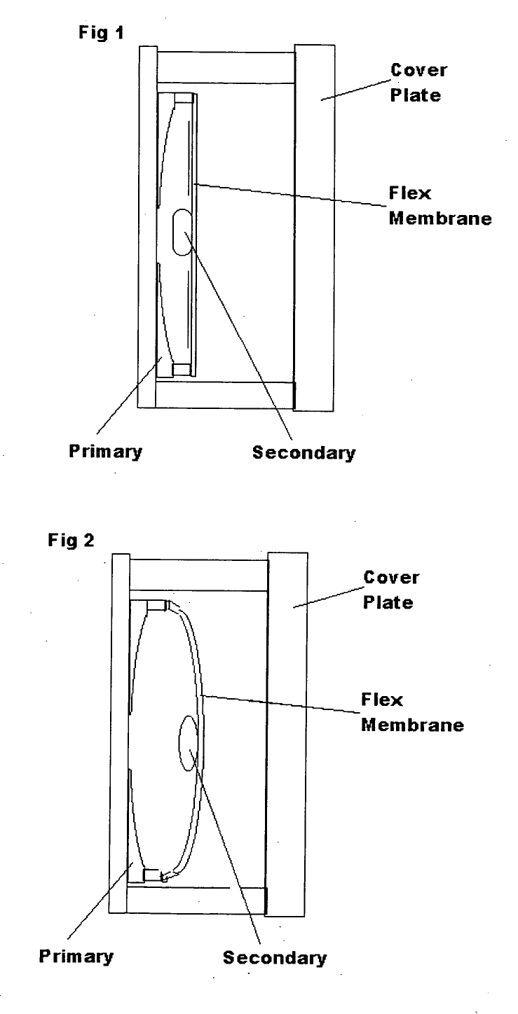

Referring now to the drawings more particularly by reference numbers, an exemplary cell in accordance with an embodiment of the present invention is shown in FIGS. 1 and 2.

In one embodiment, display technology incorporates mirror surfaces or combinations of lenses and mirror surfaces to create displays of improved qualities.

In one embodiment of the present invention, display technology incorporates catadioptric elements. A catadioptric element comprises a lens and a mirror. In one embodiment of the present invention, a display uses convex reflective elements to expand the angle of view of the display. In one embodiment of the present invention, display uses a concave mirror element, which can substitute for or augment an original micro lens element. In one embodiment of the present invention, a display uses non-spherical optics to enhance the off-axis contrast.

The display may use lens-based micro-arrays of lenses and occultating disks. Occultation occurs when the disk wholly obscures the mirror. In one embodiment of the present invention, a display uses mirrors and (optionally) lenses to perform the light control and dispersion. The introduction of the mirror system allows for more degrees of freedom in the optical design and a potentially better quality display.

FIG. 1 shows a cross-section of one example of the mirror-based display in its pixel OFF state. Note that the pixel element comprises a primary reflective surface (main mirror) and a secondary reflective surface (secondary). Note the presence of a mask structure to help control scattered light from the main illumination source (light). Note that the back side of the secondary can and in several designs should be black or substantially light absorbing.

FIG. 2 shows a cross-section of one example of the mirror-based display in its pixel ON state. Note that the secondary has been traversed substantially far away from the primary and that now a light path exists from the light source to the secondary and then to the primary mirror and out the front of the display. Also note that the front of the display is not open to the air, but has a cover plate. This plate has obvious value as a protection of the delicate mechanism of the mirror/secondary structure, and non-obvious value in improving the optical performance of the optical array by means of aberration reduction if it is correctly placed.

In this invention the primary optical element is the primary mirror. This structure is most easily fabricated with an optically sensitive polymer material (e.g., SU-8 photosensitive epoxy resin) and a mask material that has a graded opacity from center to edge of the mirror element. The exact optical shape of the mirror is sensitively related to the proper grading of the fabrication mask, and some ability for the optical design to tolerate small amounts of manufacturing imperfections will be required.

The secondary can be created using photosensitive resins as described above, but can also be created by the process of metal film lift-off.

A system of electrostatic connections on the primary mirror and on the foil that holds the secondary is required. The primary mirror can use either reflective materials such as aluminum, or transparent materials like ITO. The flexible foil can use similar materials, depending on the optical efficiency needed.

With the addition of an illumination source behind the primary mirror, the pixel design is complete.

In one embodiment of the present invention, the electromechanical display includes a mask structure. Occultating disks provide a light regulation mechanism. To improve the off axis contrast of the micro lens array, the mask is incorporated into the display pixel, approximately coplanar with the layer previously identified as layer “C”. This mask has an open diameter substantially identical to the diameter of the occultating disk for a given pixel. When the occultating disk is in the OFF condition, the disk and mask substantially obstruct the light from the illumination source in the back of the display (behind layers “D” and “E”.) When in the ON condition, the occultating disk is moved away from the mask assembly, and light is allowed to travel around the edge of the mask and occultating disk.

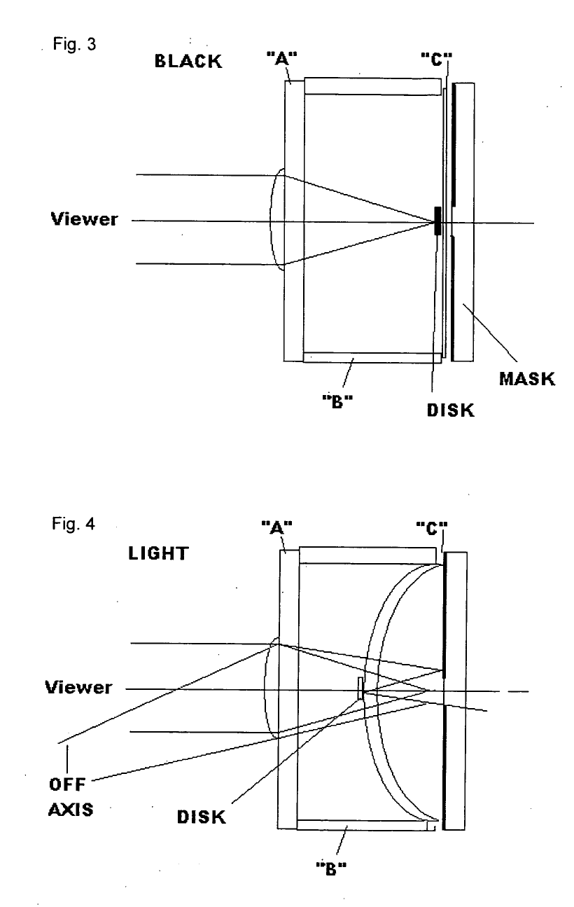

In FIG. 3, a layer, called the “mask” layer has been introduced into the microelectromechanical backplane. The mask's primary roles are to obstruct the illumination light source when the occultating disk is in the OFF position, thereby improving the on axis contrast of the black pixel, and substantially improving the off axis contrast as well. When the occultating disk is in the ON position, the mask has no adverse effect on the optical performance. It may be counterintuitive that while the mask must be opaque, there are good reasons why it could be highly reflective to good effect.

In FIG. 4, the pixel is in the ON condition. Note that in this case the front side (toward the “A” layer) of the occultating disk is black, but that the back side of the occultating disk (toward the “E” layer) can be reflective. In this case a highly reflective front side of the mask would allow light that is bounced from the illumination source by way of the reflective side of the occultating disk to efficiently traverse to the lens. This both increases the contrast on axis, but also increases the brightness, and therefore the contrast off axis.

The mask assembly is simply incorporated into the structure of the normal S/Display, by preference between layers “C” and “D” and less desirably as a part of layer “E” or behind.

In another embodiment, an electrostatic switch and lens assembly steers an image from a display, without degradation of image quality that is accomplished by combining a micro-lens array and an occultating disk array. The occultating disk array may be independently translatable in the X, Y, and Z direction.

The micro-lens array and occultating disk array are used in combination to regulate the field of view of a display, contract and the brightness of this display.

With the lens array and an array of occultating disks are located on the “A” layer and the “C” layer of the array. If either the lens array holder (layer “A”) or the occultating disk array holder (layer “C”) is made to translate in the XY plane of the device, defining the optical axis as the Z axis of the device, the so created display will be able to alter it's optical axis direction. Altering the optical axis means that the display is now optimized for a different angle of viewing. Depending upon the application and device to be made, this change in the optical axis of the display may be a factory one-time adjustment. In this case, the display will be permanently angled. Depending on the environment of the device, the ability to make the optical axis depart from the normal to the plane of the display can mean that the display will be easier to view or less susceptible to glare.

If a mechanism for traversing in the X and/or Y direction is connected into the display layers A and/or C, then the angle of viewing can be altered dynamically with the device in the field. In a basic embodiment, the display is adjustable by the use for best viewing. In a sophisticated embodiment, the display can be connected to a computer with a camera that is observing the viewer, and the display is reoptimized for angle of view depending on where the viewer is. It would be possible for a large area display to continuously “track” a viewer in a room and optimize the viewing angle as the viewer proceeds from one task to another in the room or area. Applications for advertising immediately come to mind.

The location of the A and C layers do not have to be in registration along the optical axis of the lens array. For a permanently off-set of the display, the layers are put into a permanent registration of the occultating disks not on the axis of the optical array.

For a dynamically alterable display, either the A and/or C layers are incorporated into a structure which allows the entire layer to move in the X and/or Y axis of the display. This motion in the XY plane allows for off-set viewing.

The mechanism needed to dynamically off-set the layers A and/or C must be connected to a control device. This control device is expected to operate by means of microprocessor control, but simpler control mechanisms can be imagined.

At the time of display operation, a signal is sent to the X and Y axis actuators built into the structure of layer A and/or layer C. The selected layer experiences a mechanical movement in the XY plane, with a corresponding movement of the occultating disks relative to the micro-lens array optical axis. Normal operation of the device is expected thereafter.

In one embodiment, a display includes a micro or macro lens arrays that functions as display elements by means of the translation of either a lens elements or of occultating disks incorporated into an array of microelectromechanical switches. The occultating disk structure may, but does not have to be, a part of an already extant element of the switch array. It is recognized that movement of a sub-lens assembly or the occultating disks can affect the same quality of display, but that there are numerous differences in the technologies, that can lead to various engineering solutions. Advantageously, the present display elements may be latched and the gray-scale function of the switch array can be incorporated into this invention.

Advantageously, the display can be either transmissive or reflective in operation.

The essential aspect of this invention the use of the hyper focal imagery of a lens element to regulate the apparent brightness of the lens element as observed. An opaque occultating disk is placed at the position of the exact focal length of a lens. To a viewer of the lens, the lens now looks black because all that can be seen is the hyper focal image of the dark disk. Either the lens or disk or both are now traversed along the optical axis, altering the separation to either decrease the spacing between the lens and disk or to increase the spacing. In the case of an emissive display, an illumination source behind the occultation disk is now visible through the lens. This sudden change in brightness of the lens element to an observer is the basis for this phenomenon being a display technology.

The use of occultating disks with either abrupt edges or graded edges have a variety of applications, based upon the need for high contrast of the display or a wider field of view.

From a practical engineering viewpoint, either a single lens element may be incorporated into the switch array element, or a multiplicity of lens elements, each with its own occultating disk behind it, can be incorporated into a single switch array element.

By incorporation of reflective elements into the switch array (e.g., the layer “C” flexible layer of the typical switch array) functioning both as a reflective element and also as an electrostatic element of the switch, a reflective display is possible. By incorporating partial coverage of such a reflective film, into layer C such that it would be possible to have a certain amount of light from a back light source to be seen, you would arrive at a design for a transflective display.

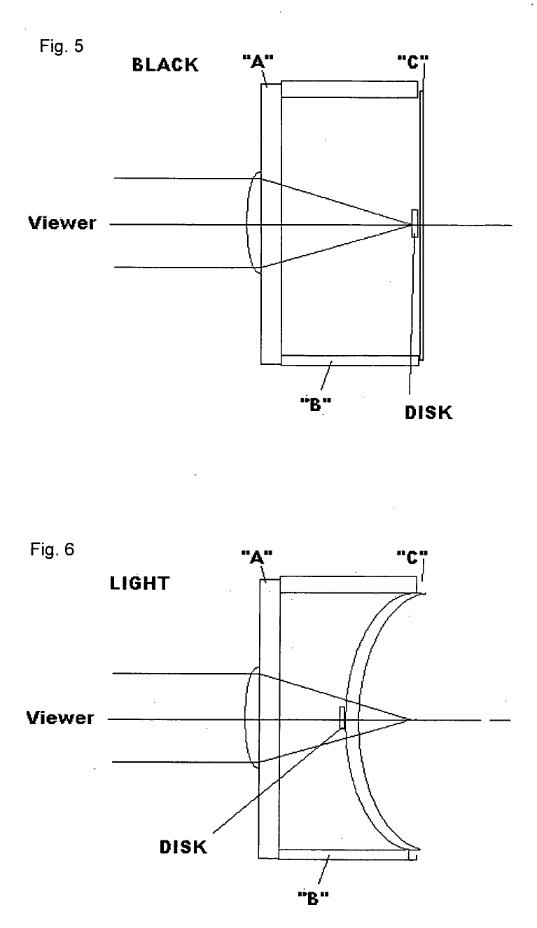

A simple layout of the display with its associated switch backplane array is as follows. The terminology developed for the switch array will be used here to identify the various layers of the array design. The basic foils of the display will be identified by the letters A-E. “Front” and “back” identification of the side of the foil will be appended to the foil letter as “f” or “b”, referenced to the viewer defined to be in the front of the display. See FIG. 5. The lens element, here shown as one element but with the understanding that a lens array is equally applicable to this technology, is adhered to the layer Af. Layer Cf has its electrical contact, typical of the switch array element, exactly centered on the optical axis of the lens. The position of the contact is exactly at the focal length of the lens. The contact has been chemically treated or deposited on such that it is dark in color. This can be done without sacrificing the electrical properties of the contact. A light source is seen to be behind the assembly D and E, although it could be incorporated into the structure of D and E, as appropriate. This light source can be diffuse or condensed, as needed for the application. As long as the spacing between the lens and the disk exactly matches the focal length of the lens, the light source will invisible to a viewer who is viewing from approximately on the optical axis of the lens.

In the normal functioning of the switch array, layer C is caused to approach layer A. See FIG. 6, in this way the disk contact is made to approach the position of the lens. The importance of this is that as soon as the disk is inside the focal length of the lens, the disk no longer effectively blocks the flow of light from the light source behind the disk. To an observer the lens will brighten noticeably as the disk comes to its final “switch element ON” position, the disk will be occultating a small area of the viewable area of the lens. The rest of the lens will be brightly illuminated from the back light source. The optical contrast ratio of such a transition can be very large.

With the present invention, it will be appreciated that it is possible to replace the silicon-on-glass thin film transistors (TFT) based backplanes with a matrix of MEM switches that are readily manufactured using inexpensive manufacturing equipment and printing process techniques. Further, it will be appreciated that the present invention enables the manufacture of scalable large optical displays on rigid or flexible plastic membranes at low cost that have an adequate and useful lifetime. Further still, the present invention enables the manufacture of optical displays that may be flexed or twisted into novel shapes while still maintaining the display properties.

There are many existing products, and potentially a large number of new products, that will benefit from an array of switches laid out in matrix pattern (sometimes uniform, sometimes not, depending on the application). With the present invention, it is possible to use the opened (or closed) switch to activate a variety of devices so needing such a switch.

With embodiments of the present invention, the array switches may include one or more of the following attributes: (a) may be physically scaled depending on the application, (b) may switch either AC or DC voltages, (c) may switch either high or low voltage, (d) may switch high or low current, and (e) may be either a momentary or latched switch. The most common need for such an array today is for flat panel displays to replace the expensive backplane based on silicon transistors layered onto glass substrates.

It will further be appreciated that one or more of the elements depicted in the drawings/figures can also be implemented in a more separated or integrated manner, or even removed or rendered as inoperable in certain cases, as is useful in accordance with a particular application.

Although the invention has been described with respect to specific embodiments thereof, these embodiments are merely illustrative, and not restrictive of the invention. For example, although the invention has been discussed primarily with respect to a two-dimensional array, many other configurations or arrangements are possible. In other embodiments it may be desirable to use other than row/column driver addressing; such as where a concentric circular arrangement is used, a random arrangement, etc. A configuration can be multi-dimensional, as where two or more cells are stacked vertically so that a pixel can be defined by multiple (e.g., red, green and blue) independent display elements. Naturally, in such a stacked configuration the cells on top should be transmissive to light emitted or reflected by underlying cells.

Although the invention has been discussed with respect to a display system, other applications are possible. For example, the array of cells can be applied with electrostatic fields by laser, electron beam or other particle or energy beam, pressure, etc., similar to technologies used in imaging systems (e.g., copiers, charge coupled devices, dosimeter, etc.) or other systems. In such an application, the driver circuitry can be replaced with sensing circuitry to detect whether a cell is in an open or closed position. Thus, a sensing array can be achieved. Embodiments may include various display architectures, biometric sensors, pressure sensors, temperature sensors, light sensors, chemical sensors, X-ray and other electromagnetic sensors, amplifiers, gate arrays, other logic circuits, printers and memory circuits.

Functionality similar to that discussed herein may be obtained with different configurations and arrangements, sizes or combinations of components. Use of the term microelectromechanical (MEM) is not intended to limit the invention. Embodiments may use components of larger or smaller size than those described herein. In other designs, components may be omitted or added. For example, additional contact pads on either the non-pliable or flexible membranes can be added. A different contact arrangement may also allow for only two contact surfaces rather than the three described herein. In other embodiments, both membranes may be made flexible. Other variations are possible.

Other types of force than electrostatic may be used to bring membranes into proximity. For example, electromagnetic, applied pressure (e.g., atmospheric or gaseous, liquid, solid), gravitational or inertial, or other forces can be used. Rather than use a force to bring two membranes into proximity, another embodiment can have an un-energized state of membranes in proximity (i.e., a closed switch state) and can use a force to cause the membranes to be brought out of proximity (i.e., an open switch state). For example, an electrostatic force can be used to cause the membranes to repel each other and break a contact connection.

Any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A display system comprising:
a lens on a first layer and an occultating disk on a second layer maintained in a spaced apart relationship by a intermediate layer; said second layer controllable to position said occultating disk alternatively at a focal point of said lens or at a non-focal point of said lens.

2. The display system of claim 1 comprising a mask layer to improve contrast.

3. The display system of claim 2 wherein display is emissive.

4. The display system of claim 2 wherein said display is reflective.

5. The display system of claim 2 further comprising means for translating the second membrane relative to said first membrane.

6. The display system of claim 2 further comprising a mask positioned such that said second membrane is sandwiched between said mask and said first membrane.

7. The display system of claim 1 further comprising catadioptric elements.

8. The display system of claim 1 further comprising a lens and a mirror.

9. The display system of claim 1 further comprising a convex reflective element to expand the viewing angle of said display.

10. The display system of claim 4 further comprising a concave mirror element.

11. The display system of claim 1 further comprising a non-spherical optics to enhance the off-axis contrast.

12. The display system of claim 1 further comprising an array of lenses.

13. A display system comprising a plurality of pixels, each of which includes a lens on a first layer and an occultating disk on a second layer maintained in a spaced apart relationship by a intermediate layer; said second layer controllable to position said occultating disk alternatively at a focal point of said lens or at a non-focal point of said lens.
